(19) United States
(12) Patent Application Publication
(10) Pub. No.: US 2004/0179738 A1
(43) Pub. Date: Sep. 16, 2004

(54) System and method for acquiring and processing complex images

(76) Inventors: X. Long Dai, Round Rock, TX (US); Ayman El-Khashab, Austin, TX (US); Martin A. Hunt, Austin, TX (US); Mark Schulze, Austin, TX (US); Clarence E. Thomas, Austin, TX (US); Edgar Voelkl, Austin, TX (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/661,187

(22) Filed: Sep. 12, 2003

Related U.S. Application Data
(60) Provisional application No. 60/410,240, filed on Sep. 12, 2002.
(60) Provisional application No. 60/410,157, filed on Sep. 12, 2002.
(60) Provisional application No. 60/410,153, filed on Sep. 12, 2002.
(60) Provisional application No. 60/410,152, filed on Sep. 12, 2002.

(51) Int. Cl. G06K 9/68; G06K 9/64; G06K 9/32

(52) U.S. Cl. 382/218; 382/278; 382/294

(57) ABSTRACT

In digital holographic imaging systems, streamed holograms are compared on a pixel-by-pixel basis for defect detection after hologram generation. An automated image matching, registration and comparison method with feedback confidence allows for runtime wafer inspection, scene matching refinement, rotational wafer alignment and the registration and comparison of difference images.

### CROSS REFERENCE TO RELATED APPLICATIONS

This application claims priority from U.S. Provisional Patent Application Serial No. 60/410,240, filed Sep. 12, 2002, and entitled “System and Method of Image Matching and Registration with an Automated Multi-View Target Searching Mechanism,” U.S. Provisional Patent Application Serial No. 60/410,157, filed Sep. 12, 2002, and entitled “System and Method for Comparing Holographic Images,” Application Serial No. 60/410,153, filed Sep. 12, 2002, and entitled “System and Method of Aligning Difference Images” and Application Serial No. 60/410,152, filed Sep. 12, 2002, and entitled “System and Method of Generating a Difference Between Complex Images.”

### TECHNICAL FIELD OF THE INVENTION

The present invention relates in general to the field of data processing and more specifically to a system and method for acquiring and processing complex images.

### BACKGROUND OF THE INVENTION

Holograms captured with a digital acquisition system contain information about the material characteristics and topology of the object being viewed. By capturing sequential holograms of different instances of the same object, changes between objects can be measured in several dimensions. Digital processing of the holograms allows for a direct comparison of the actual image waves of the object. These image waves contain significantly more information on small details than conventional non-holographic images, because the image phase information is retained in the holograms, but lost in conventional images. The end goal of a system that compares holographic images is to quantify the differences between objects and determine if a significant difference exists.

The process of comparing holograms is a difficult task because of the variables involved in the hologram generation process and object handling. In particular, in order to effectively compare corresponding holographic images, two or more holographic images must be acquired and registered or “matched” such that the images closely correspond. Additionally, after the holographic images are acquired and registered, the images are compared to determine differences between the images. Existing techniques for registering and comparing corresponding images often requires significant processing and time. Such time and processing requirements limit the throughput and overall efficiency of digital holographic imaging systems.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a flow diagram showing an intensity based registration method;

FIG. 2 is a flow diagram showing a magnitude based registration method;

FIG. 3 is a flow diagram showing a registration method for holographic phase images;

FIG. 4 is a flow diagram showing a registration method for holographic complex images;

FIG. 5 is a flow diagram of a simplified registration system that eliminates the confidence value computation;

FIG. 6 is a flow diagram showing a simplified registration system for holographic complex images;

FIG. 7 is demonstrative diagram of a wafer for determining positional refinement;

FIG. 8 is a diagram of a digital holographic imaging system;

FIG. 9 is an image of a hologram acquired from a CCD camera;

FIG. 10 is an enlarged portion of FIG. 10 showing fringe detail;

FIG. 11 is a holographic image transformed using a Fast Fourier Transform (FFT) operation;

FIG. 12 is a holographic image showing a sideband;

FIG. 13 is a quadrant of a hologram FFT centered at the carrier frequency;

FIG. 14 shows the sideband of FIG. 14 after application of a Butterworth lowpass filter;

FIG. 15 shows a magnitude image;

FIG. 16 shows a phase image;

FIG. 17 shows a difference image;

FIG. 18 shows a second difference image;

FIG. 19 shows a thresholded difference image;

FIG. 20 shows a second thresholded difference image;

FIG. 21 shows an image of two thresholded difference images following a logical AND operation;

FIG. 22 shows a magnitude image with defects; and

FIG. 23 shows a phase image with defects.

### DETAILED DESCRIPTION

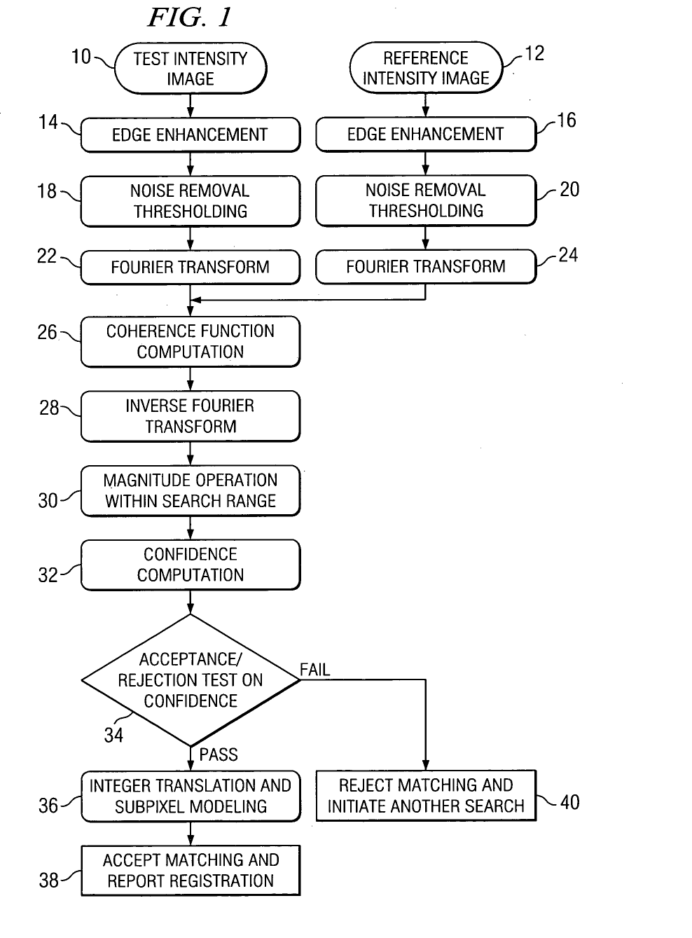

Preferred embodiments and their advantages are best understood by reference to FIGS. 1 through 23, wherein like numbers are used to indicate like and corresponding parts.

The following invention relates to digital holographic imaging systems and applications as described, for instance, in U.S. Pat. No. 6,078,392 entitled Direct-to-Digital Holography and Holovision, U.S. Pat. No. 6,525,821 entitled, Improvements to Acquisition and Replay Systems for Direct to Digital Holography and Holovision, U.S. patent application Ser. No. 09/949,266 entitled System and Method for Correlated Noise Removal in Complex Imaging Systems now issued as U.S. Pat. No. ______ and U.S. patent application Ser. No. 09/949,423 entitled, System and Method for Registering Complex Images now issued as U.S. Pat. No. ______, all of which are incorporated herein by reference.

The present invention encompasses the automated image registration and processing techniques that have been developed to meet the special needs of Direct-to-Digital Holography (DDH) defect inspection systems as described herein. In DDH systems, streamed holograms may be compared on a pixel-by-pixel basis for defect detection after hologram generation.

One embodiment of the present invention includes systems and methods for automated image matching and registration with a feedback confidence measure are described below. The registration system provides a techniques and algorithms for multiple image matching tasks in DDH systems, such as runtime wafer inspection, scene matching refinement, and rotational wafer alignment. In some embodiments, a system for implementing this registration system may include several major aspects including: a search strategy, multiple data input capability, normalized correlation implemented in the Fourier domain, noise filtering, correlation peak pattern search, confidence definition and computation, sub-pixel accuracy modeling, and automated target search mechanism.

Image Registration

The Fourier transform of a signal is a unique representation of the signal, i.e. the information contents are uniquely determined by each other in two different domains. Therefore, given two images with some degree of congruence, f₁(x,y) and f₂(x,y), with Fourier transforms, F1(wₓ,w_{y}) and F2(wₓ,w_{y}), their spatial relationship can also be uniquely represented by the relationship between their Fourier transforms. For example, an Affine transformation between two signals in the spatial domain can be represented uniquely by their Fourier transforms based on the shifting theorem, scaling theorem, and rotational theorem of the Fourier transform. If there is an affine transformation between f₁(x,y) and f₂(x,y), their spatial relationship can be expressed as:

$$[ \begin{matrix}{x}^{′} \\ {y}^{′ }\end{matrix} ] = [ \begin{matrix}a & b \\ c & d\end{matrix} ] [ \begin{matrix}x \\ y\end{matrix} ] + [ \begin{matrix}{x}_{0} \\ {y}_{0}\end{matrix} ]$$

where

$$A = [ \begin{matrix}a & b \\ c & d\end{matrix} ]$$

represents rotational, scaling, and skew differences; and

$$[ \begin{matrix}{x}_{0} \\ {y}_{0}\end{matrix} ]$$

represents translations. If it is a noise-free environment, the two images are related to each other by:

f₁(x,y)=f₂(ax+by+x₀,cx+dy+y₀);

and their Fourier transforms are related as follows:

$${F}_{2} ( {w}_{x} , {w}_{y} ) = \vert A \vert {F}_{1} ( {A}^{T} [ \begin{matrix}{w}_{x} \\ {w}_{y}\end{matrix} ] ) \cdot {ⅇ}^{- j ( {w}_{x} {x}_{0} + {w}_{y} {y}_{0} )} ,$$

where A^{T} denotes the transpose of A and |A| is its determinant. The importance of this derivation is that this equation separates the affine parameters into two groups in the Fourier space: translations and linear transformation, which tells us that the translations are determined by Fourier phase difference while magnitude is shift-invariant and related to each other by the linear component |A|.

In the simplest case: translation model, i.e. one image is simply a shifted version of another image, as in:

f₁(x,y)=F₂(x+x₀,y+y₀).

Their Fourier transforms have the following relationship:

F₂(wₓ,w_{y})=F₁(wₓ,w_{y})·e^{j(w}^{ₓ}^{x}^{₀}^{+w}^{_{y}}^{y}^{₀}),

based on the Fourier shift theorem, which is equivalent to:

$$\frac{{F}_{2} ( {w}_{x} , {w}_{y} ) {F}_{1}^{*} ( {w}_{x} , {w}_{y} )}{\vert {F}_{2} ( {w}_{x} , {w}_{y} ) {F}_{1}^{*} ( {w}_{x} , {w}_{y} ) \vert} = {ⅇ}^{j ( {w}_{x} {x}_{0} + {w}_{y} {y}_{0} )} .$$

The left-hand side of the equation above is the cross power spectrum normalized by the maximum power possible of two signals. It is also called coherence function. Two signals have the same magnitude spectra but a linear phase difference corresponding to spatial translations. The coherence function of two images, Γ₁₂(wₓ,w_{y}), is also related to their cross correlation defined by power spectral densities (PSD) and cross power spectral density (XPSD) by

$${Γ}_{12} ( {w}_{x} , {w}_{y} ) = \frac{xpsd}{\sqrt{{psd}_{1} \cdot {psd}_{2}}} ,$$

where xpsd is the cross power spectral density of the two images, and psd₁ and psd₂ are the power spectral densities of f₁ and f₂ respectively. Assuming it is a stationary stochastic process, its true PSD is the Fourier transform of the true autocorrelation function. The Fourier transform of the autocorrelation function of an image provides a sample estimate of the PSD. By the same token, cross power density xpsd can be estimated by the 2-D Fourier transform of f₂ multiplied by the complex conjugate of the 2-D Fourier transform of f₁. Therefore, the coherence function of two images may be estimated by

$${Γ}_{12} ( {w}_{x} , {w}_{y} ) ≅ \frac{{F}_{2} ( {w}_{x} , {w}_{y} ) {F}_{1}^{*} ( {w}_{x} , {w}_{y} )}{\vert {F}_{2} ( {w}_{x} , {w}_{y} ) {F}_{1}^{*} ( {w}_{x} , {w}_{y} ) \vert}$$

The coherence function above is a function of spatial frequency with its magnitude indicating the amplitude of power present in the cross-correlation function. It is also a frequency representation of cross correlation (CC), i.e. the Fourier transform of cross correlation, as indicated by the correlation theorem of the Fourier transform:

f₁(x,y) [symbol] f₂(x,y) [symbol] F₂(wₓ,w_{y})F₁(−wₓ,−w_{y}

where [symbol] denotes spatial correlation. For real signal, the Fourier transform is conjugate symmetric, i.e.

F₁(−wₓ,−w_{y})=F₁(wₓ,−w_{y})

The maximum correlated power possible is an estimate of \sqrt{psd1·psd2}. The magnitude-squared coherence, |Γ₁₂(wₓ,w_{y})|², is a real function between 0 and 1 which gives a measure of correlation between the two images at each frequency. At a given frequency, when the correlated power is the same as the maximum correlated power possible, the two images observe the same patterns and the powers only varies by a scale factor. In this case, CC=1. When the two images have different patterns, the powers will be out of phase in the two power spectrum densities and the cross-power spectral density will have lower power than the maximum possible case. For these reasons, the coherence function can be used in image matching and the coherence value is a measure of correlation between the two images.

Based on the theory described above, the matching position of the two images, i.e. point of registration, can be derived by locating where the maximum CC is in the spatial domain. The inverse Fourier transform of CC (i.e. an estimate of the coherent function) is

$${F}^{- 1} ( \frac{{F}_{2} ( {w}_{x} , {w}_{y} ) {F}_{1}^{*} ( {w}_{x} , {w}_{y} )}{\vert {F}_{2} ( {w}_{x} , {w}_{y} ) {F}_{1}^{*} ( {w}_{x} , {w}_{y} ) \vert} ) = {F}^{- 1} ( {ⅇ}^{j ( {w}_{x} {x}_{0} + {w}_{y} {y}_{0} )} ) = δ ( {x}_{0} , {y}_{0} ) ,$$

which is a Dirac delta function. This is the representation of CC in the spatial domain and the position of the delta function is exactly where the registration is located.

For real signal and system with limited bandwidth (finite size of discrete Fourier transform) and assumption of periodic extension of spatial signal, the delta function becomes a unit pulse. Given two signals with some degree of congruence, signal power in their cross power spectrum is mostly concentrated in a coherent peak in the spatial domain, located at the point of registration. Noise power is distributed randomly in some coherent peaks. The amplitude of the coherent peak is a direct measure of the congruence between the two images. More precisely, the power in the coherent peak corresponds to the percentage of overlapping areas, while the power in incoherent peaks correspond to the percentage of non-overlapping areas.

Effect of Noise, Feature Space Selection, and Filters

Ideally, the coherence of the features of interest should be 1 at all frequencies in the frequency domain and a delta pulse at the point of registration in the spatial domain. However, noise will typically distort the correlation surface. These noises include time-varying noise (A/C noise) such as back-reflection noise, carrier drifting, and variation caused by process change, fixed-pattern noise (D/C noise) such as illumination non-uniformity, bad pixels, camera scratch, dusts on optical path, and focus difference, and stage tilting; and (3) random noise.

If these noises are present, one may think of one image as a superposition of three images in both additive and multiplicative ways:

fₙ(x,y)=Nₘ(x,y)*f(x,y)+Nₐ(x,y)

where Nₘ(x,y) is multiplicative noise source; Nₐ(x,y) is an additive noise source; and fₙ(x,y) is the signal distorted by noise.

Fₙ(x,y)=Fₘ(x,y) [symbol] F(x,y)+Fₐ(x,y)

where Fₘ(x,y) is the Fourier transform of the multiplicative noise source; Fₐ(x,y) is the Fourier transform of the additive noise source; and Fₙ(x,y) is the Fourier transform the signal distorted by noise.

The observed signal is fₙ(x,y) with its Fourier transform Fₙ(x,y). The objective of noise processing is to make the coherent peak converge on the signal only. There are primarily two ways to achieve this goal: (1) to reconstruct its original signal f(x,y) or its original Fourier transform F(x,y) from the observed signal; (2) to reduce the noise as much as possible to increase the probability of convergence on the signal even the signal is partially removed or attenuated.

The first method of noise removal requires noise modeling with each noise source typically requiring a different model. The second method focuses on noise removal by any means even it also removes or attenuates the signal, which gives us much more room to operate. Therefore, we mainly use the second technique for the task of image matching. Furthermore, it is beneficial to think of the issue in both spatial domain and frequency domain. The observations below have been considered in the design of noise resistant registration systems:

First, all frequencies generally contribute equally, therefore, narrowly-banded noise is more easily handled in frequency domain.

Second, image data obtained under different illumination usually show slow-varying difference. Illumination non-uniformity usually appears as low-frequency variation across the image.

Also, carrier drifting in frequency domain, i.e. phase tilt in spatial domain is low frequency.

stage tiling, slow change in stage height, and process variation are mostly low frequency noise. A/C noise is generally low frequency. Out-of-focus dusts are also at the lower side in the frequency domain. Back-reflection noise is mostly relatively low frequency.

Random noise is typically at relatively high frequency. Both low frequency noise and high frequency noise are harmful to any mutual similarity measure and coherent peak convergence.

High frequency contents are independent of contrast reversal. A frequency-based technique is relatively scene independent and multi-sensor capable since it is insensitive to changes in spectral energy. Only frequency phase information is used for correlation, which is equivalent to whitening of each image and whitening is invariant to linear changes in brightness and makes correlation measure independent.

Cross correlation is optimal if there is white noise. Therefore, a generalized weighting function can be introduced into phase difference before taking the inverse Fourier transform. The weighting function can be chosen based on the type of noise immunity desired. So there are a family of correlation techniques, including phase correlation and conventional cross correlation.

For these reasons, the feature space can use prominent edges, contours of intrinsic structures, salient features, etc. Edges characterize object boundaries and are therefore useful for image matching and registration. The following are several candidate filters to extract these features.

A Butterworth low pass filter is used to construct the BPF as follows:

$$weight = \frac{1}{1 + {( \frac{r}{{cutoff}_{2}} )}^{2 \cdot order}} - \frac{1}{1 + {( \frac{r}{{cutoff}_{1}} )}^{2 \cdot order}} ,$$

where order is the Butterworth order; r is the distance to DC; cutoff₁ and cutoff₂ are the cutoff frequencies at low end and high end respectively; and weight is the filter coefficient for the point.

The BPF can be used to choose any narrow band of frequency.

Edge Enhancement Filters in the Spatial Domain

Edge enhancement filters are used to capture information in edges, contours, and salient features. Edge points can be thought of as pixel locations of abrupt gray-level change. For a continuous image f(x,y), its derivative assumes a local maximum in the direction of the edge. Therefore, one edge detection technique is to measure the gradient of f along r in a direction θ. The maximum value of ∂f/∂r is obtained when (∂/∂θ)(∂f/∂θ)=0. This gives:

$$\begin{matrix}{( \frac{\partial f}{\partial r} )}_{max} = \sqrt{{( \frac{\partial f}{\partial x} )}^{2} + {( \frac{\partial f}{\partial y} )}^{2}} , and \\ {θ}_{edge} = arctan ( \frac{\partial f}{\partial y} / \frac{\partial f}{\partial x} )\end{matrix}$$

They can be re-written in digital form,

g(x,y)=g²ₓ(x,y)+g²_{y}(x,y), and

$$θ ( x , y ) = arctan ( \frac{{g}_{y} ( x , y )}{{g}_{x} ( x , y )} )$$

where gₓ(x,y) and g_{y}(x,y) are orthogonal gradients along X and Y directions, obtained by convolving the image with a gradient operator. To save computations, the magnitude gradient is often used

g(x,y)=|gₓ(x,y)+|g_{y}(x,y)|

The following lists some of the common gradient operators.

$$Gradient {H}_{x} = [ \begin{matrix}- 1 & 1\end{matrix} ] {H}_{y} = [ \begin{matrix}- 1 \\ 1\end{matrix} ]$$

$$Roberts {H}_{x} = [ \begin{matrix}0 \\ - 1\end{matrix} \begin{matrix}1 \\ 0\end{matrix} ] {H}_{y} = [ \begin{matrix}1 \\ 0\end{matrix} \begin{matrix}0 \\ - 1\end{matrix} ]$$

$$Sobel {H}_{x} = [ \begin{matrix}- 1 & 0 & 1 \\ - 2 & 0 & 2 \\ - 1 & 0 & 1\end{matrix} ] {H}_{y} = [ \begin{matrix}- 1 & - 2 & - 1 \\ 0 & 0 & 0 \\ 1 & 2 & 1\end{matrix} ]$$

The first order derivative operators work best when the gray-level transition is quite abrupt, like a step function. As the transition region gets wider, it is more advantageous to apply the second-order derivatives. Besides, these operators require multiple filter passes, one in each primary direction. This directional dependence can be eliminated by using the second-order derivative operators. In some embodiments, a direction-independent Laplacian filter is preferred and defined as

$${∇}^{2} f = \frac{{\partial }^{2} f}{{\partial }^{2} x} + \frac{{\partial }^{2} f}{{\partial }^{2} y}$$

The typical filter H has the form

$$H = [ \begin{matrix}- 1 & - 1 & - 1 \\ - 1 & C & - 1 \\ - 1 & - 1 & - 1\end{matrix} ]$$

where C is a parameter that controls the contents. The value C=8 creates an edge-only filter, and sharp edges in the original appear as a pair of peaks in the filtered image. Values of C greater than 8 combine the edges with the image itself in different proportions, and thereby create an edge enhancement image.

In some instances, to increase correlation peak height, it is also desirable to thicken the edges. However, this process also broadens correlation peak and hence reduces registration accuracy. It is maybe useful for low-resolution match in a multi-resolution scheme.

In general, the purposes of edge enhancement filter in spatial domain are: (1) to control information contents to enter the registration flow; (2) to transform the feature space; (3) to capture edge information of salient features; (4) to sharpen correlation peak of signal; (5) to solve the intensity reversal problem; and (6) to have broader boundaries than edge detection or first derivative.

Thresholding in the Spatial Domain

The edge enhanced image still typically contains noise. However, the noise appears much weaker in the edge strength than intrinsic structures, and therefore, the edge-enhanced features can further be thresholded to remove points with small edge strength. In some embodiments thresholding the filtered image can eliminate most of the A/C noise, D/C noise, and random noise.

Threshold may be selected automatically by computing the standard deviation, σ, of the filtered image and using it to determine where the noise can be optimally removed and there is still sufficient signal left for correlation. The threshold is defined as

threshold =numSigma·σ

where numsigma is a parameter that controls the information contents entering the registration system. This parameter is preferably set up empirically.

After thresholding, the points below the threshold are preferably disabled by zeroing them out, while the rest of the points with strong edge strength are able to pass the filter and enter the following correlation operation. Notably, the idea of edge enhancement to boost the robustness and reliability of area-based registration is from the feature-based techniques. However, unlike the feature-based techniques, the image is not thresholded to binary image. The filtered image is still gray-scale ata by keeping the edge strength values of these strong dge points. The advantage of doing this is that the edge strength values of different edge points carry the locality information of edges. The different locality information will vote differently in the correlation process. Therefore, this technique preserves the registration accuracy.

Confidence of Image Matching

This discussion is about correlation surface and the coherent peaks on the surface. As used in this discussion, features are the features of dominance, i.e. the major features in the scene. There are two types of peaks on a correlation surface: coherent peaks and incoherent peaks. All peaks corresponding to features are coherent; all other peaks are incoherent, i.e. corresponding to noise.

Some examples of coherent peaks are as follows:

Periodic signals with periods Tx and Ty in X and Y produce multiple periodic coherent peaks with the same periods. These peaks have approximately equal strengths, with the highest most likely at the center and peaks with fading strengths towards the edge.

Any locally repetitive signals also produce multiple coherent peaks. The highest coherent peak is most likely at the point of registration and all other secondary peaks are corresponding to local feature repetitiveness.

In many cases, correlation surface exhibits the behavior of a Sinc function typically seen as the response characteristics due to finite size of discrete Fourier transform in a system with limited bandwidth. The main lobe has the highest peak where the algorithm should converge at, but there are also multiple secondary lobes with peaks.

Incoherent peaks occur when noise exists. Random noise power is distributed randomly in some coherent peaks. Both A/C and D/C noises will bias, distort, and diverge the coherent peaks. Noise will also peal, fork, blur the coherent peaks.

The amplitude of the coherent peak is a direct measure of the congruence between the two images. More precisely, the power in the coherent peak corresponds to the percentage of dominant features in overlapping areas, while the power in incoherent peaks correspond to the percentage of noise and non-overlapping areas.

Therefore, the following two metrics are developed and used together to evaluate the quality of an image matching: First, the height of the first coherent peak. Second, the difference in strength, i.e. correlation coefficient, between the first coherent peak and the second peak, either coherent or incoherent.

An additional advantage using these metrics is that they are computed based on the correlation surface that is already available in real-time while computing alignment differences. The efficiency and real-time speed are critical in most image matching application where a real-time confidence feedback signal is key to a successful automated target search systems such as wafer rotational alignment where an automated multi-FOV search is required.

Search Space and Subpixel Modeling

The task of the search strategy is often trivial in this implementation of registration since the whole correlation surface is already available, after inverse Fourier transform, for searching. The point of registration is the maximum peak of magnitude correlation surface. One scan for the peak across the entire search space is typically sufficient. This is the integer registration detected.

To find out the subpixel offsets, a subpixel modeling is done as follows. A 2D parabola surface can be defined as

Z=ax²+by²+cxy+dx+ey+f.

This second-order polynomial is fit to 3×3-point correlation surface around the integer peak at (0,0).

$$[ \begin{matrix}{Z}_{1} \\ {Z}_{2} \\ … \\ {Z}_{9}\end{matrix} ] = [ \begin{matrix}{x}_{1}^{2} & {y}_{1}^{2} & {x}_{1} {y}_{1} & {x}_{1} & {y}_{1} & 1 \\ {x}_{2}^{2} & {y}_{2}^{2} & {x}_{2} {y}_{2} & {x}_{2} & {y}_{2} & 1 \\ … & … & … & … & … & 1 \\ {x}_{9}^{2} & {y}_{9}^{2} & {x}_{9} {y}_{9} & {x}_{9} & {y}_{9} & 1\end{matrix} ] [ \begin{matrix}a \\ b \\ c \\ d \\ e \\ f\end{matrix} ]$$

where (x,y)'s are the coordinates of these 9 points, which can be simplified to [−1, 0, 1] for both x and y. A least-squared solution to the equation above based on matrix pseudo-inverse operation gives an estimate for the coefficients:

$$[ \begin{matrix}a \\ b \\ c \\ d \\ e \\ f\end{matrix} ] = {[ \begin{matrix}{x}_{1}^{2} & {y}_{1}^{2} & {x}_{1} {y}_{1} & {x}_{1} & {y}_{1} & 1 \\ {x}_{2}^{2} & {y}_{2}^{2} & {x}_{2} {y}_{2} & {x}_{2} & {y}_{2} & 1 \\ … & … & … & … & … & 1 \\ {x}_{9}^{2} & {y}_{9}^{2} & {x}_{9} {y}_{9} & {x}_{9} & {y}_{9} & 1\end{matrix} ]}^{- 1} [ \begin{matrix}{Z}_{1} \\ {Z}_{2} \\ … \\ {Z}_{9}\end{matrix} ]$$

The subpixel locations of registration within this 3×3 block are found at the peak locations of the parabola, which are determined by taking the partial derivatives of the parabola equation with respect to x and y and set them to zeros

$$\frac{\partial Z}{\partial x} = 2 ax + cy + d = 0$$

$$\frac{\partial Z}{\partial y} = 2 by + cx + e = 0$$

$$which gives$$

$$x = \frac{2 db - ce}{{c}^{2} - 4 ab}$$

$$y = \frac{2 ae - d c}{{c}^{2} - 4 ab}$$

The coordinates of the integer peak and subpixel offsets are used to determine final registration offsets of the whole image.

FIG. 1 shows an implementation of an intensity based registration method. The method begins with providing test intensity image 10 (which may also be referred to as a first image) and reference intensity image 12. Both images are separately edge enhanced 14 and 16 and then noise is removed from the edge enhanced images using thresholding operations 18 and 20. The images are then transformed 22 and 24 using a Fourier transform.

The two transformed images are then used to in coherence function computation 26 and an inverse Fourier transform is applied thereto 28. Next a magnitude operation is performed within a selected search range 30. A confidence computation is then performed 32 and the match of the images may then be either accepted or rejected 34 based on the confidence value derived therefrom. If the confidence value is within an acceptable range, the registration process proceeds to integer translation and subpixel modeling 36 and the match of the images is accepted 38. If the confidence value is not within an acceptable range, a new search is initiated 40.

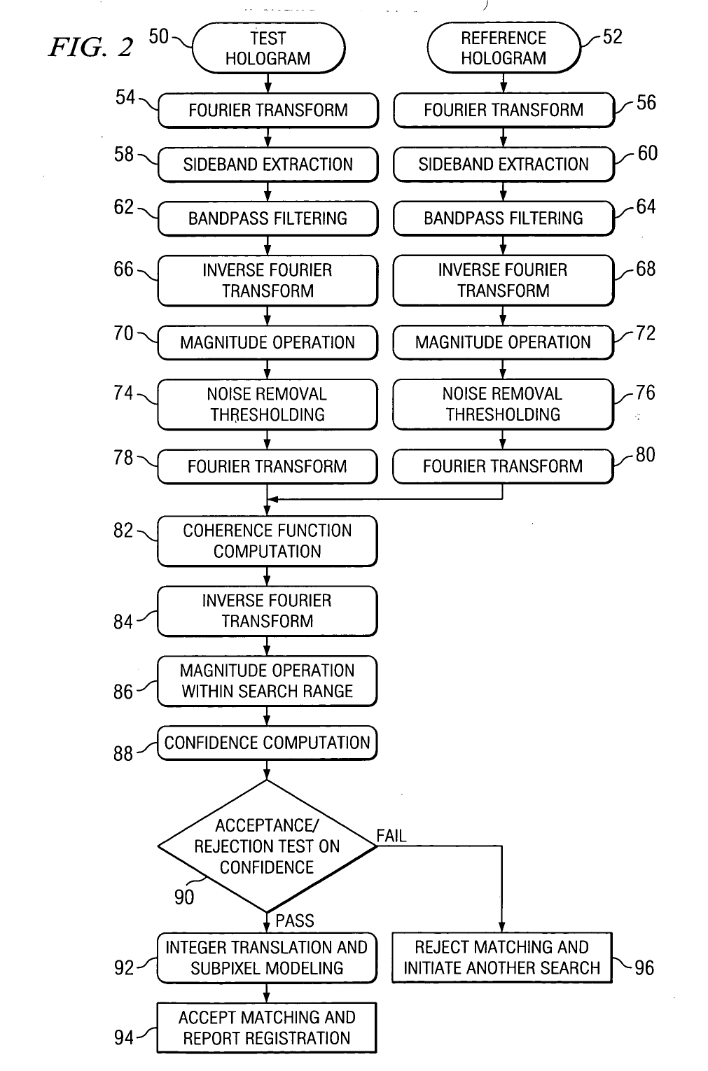

FIG. 2 shows an implementation of a magnitude based registration method. The method begins with providing test hologram 50 and reference hologram 52. Both holograms are separately transformed using a Fourier transform 54 and 56 and a sideband extraction is applied to each image 58 and 60. Next both image are separately filtered with a bandpass filter 62 and 64. The resulting images are then separately transformed using an inverse Fourier transform 66 and 68 and a magnitude operation is performed on each resulting image 70 and 72. The results are then thresholded 74 and 76 before being transformed using an Fourier transform operation 78 and 80.

The two transformed images are then used in coherence function computation 82 and an inverse Fourier transform is applied thereto 84. Next a magnitude operation is performed within a selected search range 86. A confidence computation is then performed 88 and the match of the images may then be either accepted or rejected 90 based on the confidence value derived therefrom. If the confidence value is within an acceptable range, the registration process proceeds to integer translation and subpixel modeling 92 and the match of the images is accepted 94. If the confidence value is not within an acceptable range, a new search is initiated 96.

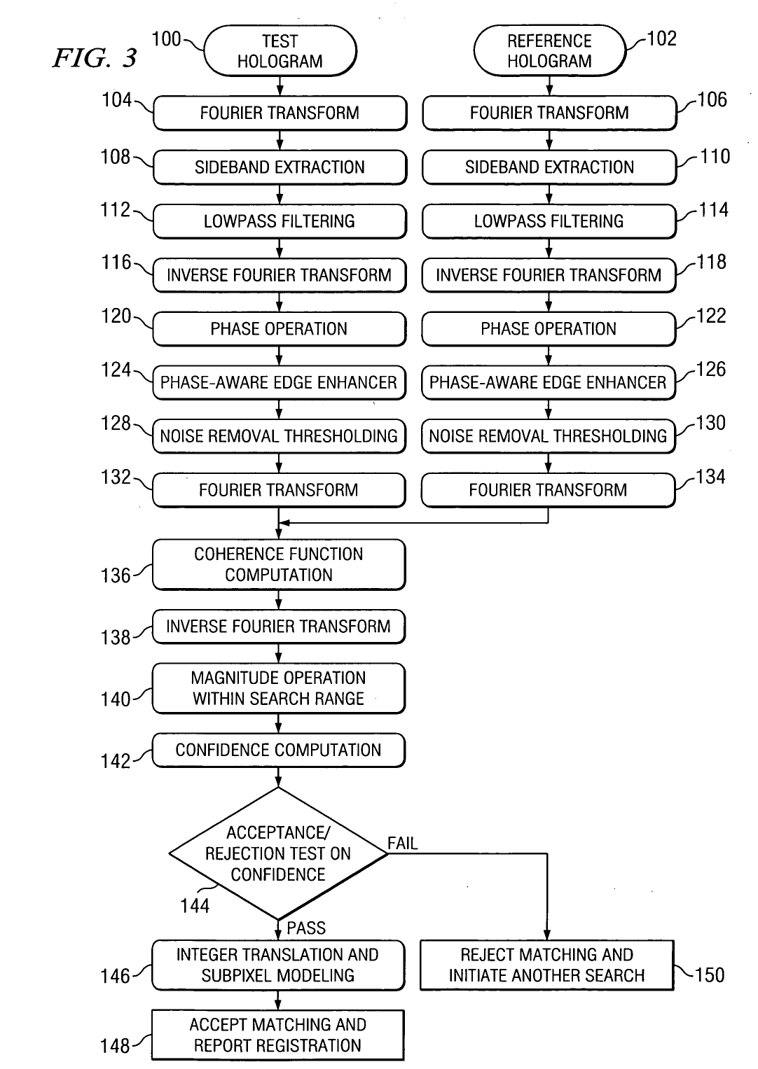

FIG. 3 shows an implementation of a phase image based registration method. The method begins with providing test hologram 100 and reference hologram 102. Both holograms are separately transformed using a Fourier transform 104 and 106 and a sideband extraction is applied to each image 108 and 110. Next, both image are separately filtered with a lowpass filter 112 and 114. The resulting images are then separately transformed using an inverse Fourier transform 116 and 118 and a phase operation is performed on each resulting image 120 and 122. A phase-aware enhancement is then performed on the resulting images 124 and 126. The results are then thresholded 128 and 130 before being transformed using an Fourier transform operation 132 and 134.

The two transformed images are then used in coherence function computation 136 and an inverse Fourier transform is applied thereto 138. Next a magnitude operation is performed within a selected search range 140. A confidence computation is then performed 142 and the match of the images may then be either accepted or rejected 144 based on the confidence value derived therefrom. If the confidence value is within an acceptable range, the registration process proceeds to integer translation and subpixel modeling 146 and the match of the images is accepted 148. If the confidence value is not within an acceptable range, a new search is initiated 150.

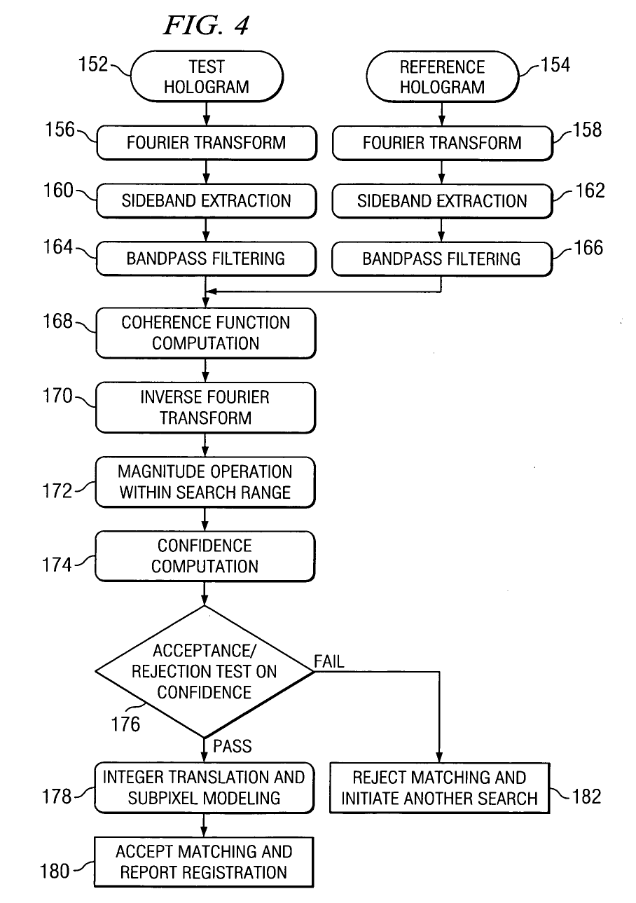

FIG. 4 shows an implementation of a complex based registration method. The method begins with providing test hologram 152 and reference hologram 154. Both holograms are separately transformed using a Fourier transform 156 and 158 and a sideband extraction is applied to each image 160 and 162. The resulting images are then filtered using a bandpass filter 164 and 166.

The two filtered images are then used in coherence function computation 168 and an inverse Fourier transform is applied thereto 170. Next a magnitude operation is performed within a selected search range 172. A confidence computation is then performed 174 and the match of the images may then be either accepted or

rejected 176 based on the confidence value derived therefrom. If the confidence value is within an acceptable range, the registration process proceeds to integer translation and subpixel modeling 178 and the match of the images is accepted 180. If the confidence value is not within an acceptable range, a new search is initiated 182.

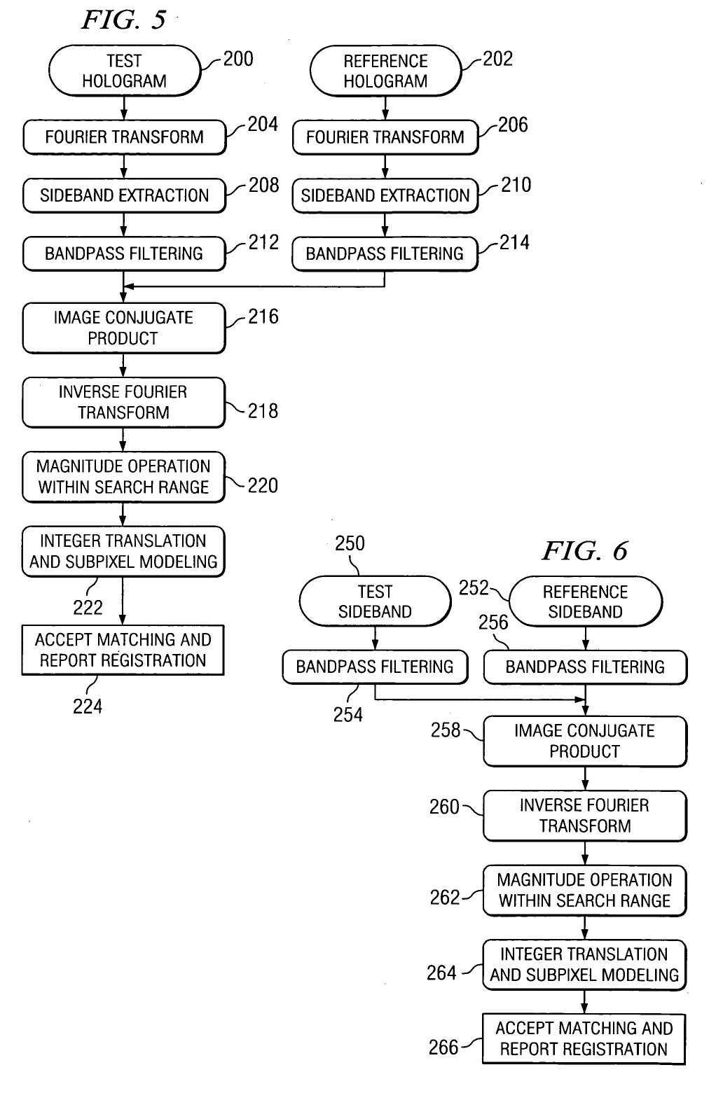

In some embodiments, simplification may be brought by eliminating confidence evaluation. The generally includes: (1) replacing coherence function computation with image conjugate product, i.e. without normalizing the cross power spectral density by maximum possible power of the two images, and (2) eliminating confidence computation and acceptance/rejection testing. The rest of the methods are essentially the same as in their original versions. As an example, the simplified version of complex-based registration system is shown in FIG. 5.

FIG. 5 shows an simplified implementation of a complex based registration method. The method begins with providing test hologram 200 and reference hologram 202. Both holograms are separately transformed using a Fourier transform 204 and 206 and a sideband extraction is applied to each image 208 and 210. The resulting images are then filtered using a bandpass filter 212 and 214.

The two filtered images are then used to determine the image conjugate product 216 and an inverse Fourier transform is applied thereto 218. Next a magnitude operation is performed within a selected search range 220. The registration process proceeds to integer translation and subpixel modeling 222 and the match of the images is accepted and reported 224

Selection of a technique or a combination of multiple techniques for a specific application is a system engineering choice and depends on many factors. Among the important factors are basic functionality required, system optimization as a whole, data stream available, convenience and feasibility of filtering implementation, result of noise filtering and robustness, overall system speed and cost, system reliability.

The following examples are given to illustrate these principles.

Runtime Defect Detection

In the application of runtime wafer inspection, system speed and accuracy are essential. For this reason, the already available complex frequency data streams can be used to the advantage. Therefore, the registration may be simplified as shown in FIG. 6.

FIG. 6 shows a simplified implementation of a method for registering holographic complex images when sidebands are available in the datastream. The method begins with providing a test sideband 250 and reference sideband 252. Both sidebands are separately using a bandpass filter 254 and 256.

The two filtered images are then used to determine the image conjugate product 258 and an inverse Fourier transform is applied thereto 260. Next a magnitude operation is performed within a selected search range 262. The registration process proceeds to integer translation and subpixel modeling 264 and the match of the images is accepted and reported 266.

Wafer Center Detection (or Die Zero or Other Point Positional Refinement.)

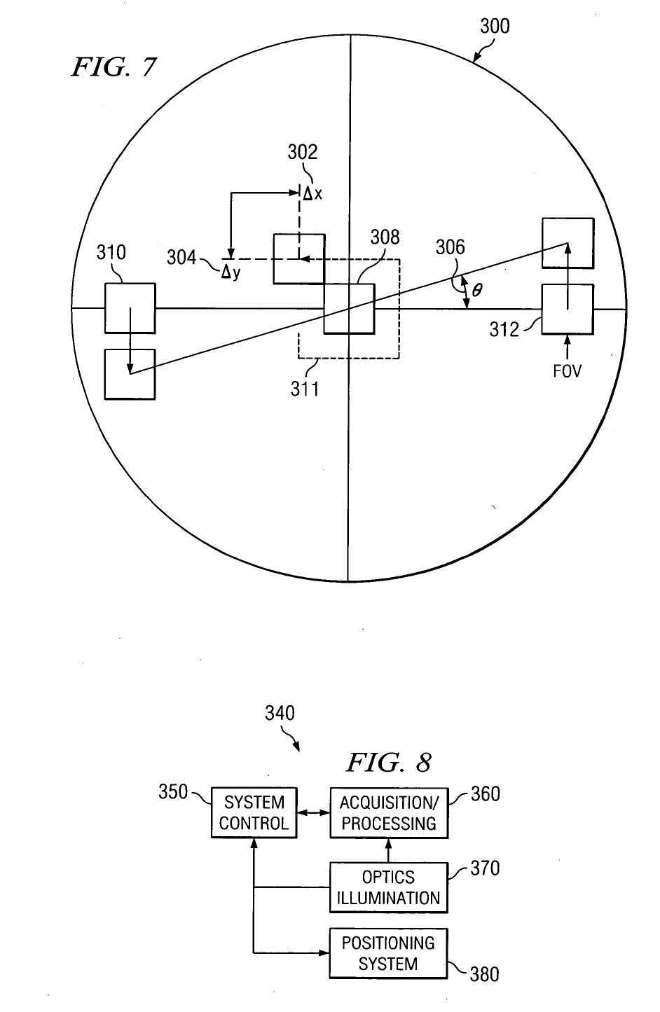

FIG. 7 shows how the registration process is applied to the aligning a wafer coordinate system to the stage coordinate system. Wafer 300 is placed on a chuck and images are acquired at candidate locations that potentially match a stored reference pattern. The procedure provided below is performed on the images to determine the offset (Δx 302, Δy 304) between the actual location of the reference pattern and the assumed location of the pattern. The second step is to repeat the registration procedure to determine and correct the rotational angle, θ306, between the die grid axis and the stage axis.

In a particular embodiment of this application, we have to use the full version of the algorithm:

Registration(translations, confidence, image1, image2, . . . )

which registers two images (of complex frequency, complex spatial, magnitude, phase, or intensity) by computing their translational differences and returns a realtime confidence measure telling if it is a successful match, the following procedures are developed for Wafer Center Detection and Rotational Angle Detection.

Given an image chip as a template (e.g. 256×256), the following steps are performed:

Step 1. take an FOV 308, image1, at the current osition where the template is taken (assuming it is an image segment with features close to the real wafer center).

Step 2. zero-pad the template to the size of image1.

Step 3. call Registration(translations, confidence, image1, padded template, . . . ).

Step 4. if (confidence.maxxCorrlst>=T1 and confidence.measure>=T2)

Stop. Output translations and compute wafer center.

Step 5. extract an image chip of 256×256 from image1 at the location based on translation detected in Step 4.

Step 6. Repeat Step 3 using template and the image chip extracted (perform 256×256 registration).

Step 7. Repeat Step 4.

Step 8. Perform a circular search 311 by taking an FOV from its neighbors with P% overlap, go to Step 3.

Step 9. Repeat Step 4, Step 5, and Step 6 until the condition in Step 4 is satisfied or signal it is out of the search range predefined.

Step 10. If no match is found within the search range, output a failure signal and handle the case.

The steps above utilize the four parameters: T1, T2, numsigma, and P%. T1 is the minimum Coors correlation coefficient; T2 is the minimum confidence value; numSigma is a noise threshold which controls the information contents entering the registration system after edge enhancement; and P% is the overlap when taking an adjacent FOV. In one embodiment, in the case of zero-padding the template, the overlapped should be>=50%*256 pixels since it only needs to cover a portion of the original template. Based on experiments, the following settings are typical for a successful search:

T1=0.4, T2=0.1, numsigma=3.5.

Other parameters are similar to those in realtime registration.

In some embodiments the padding scheme can also be replaced with a tiling scheme.

Rotational Angle Detection

To identify rotational angle detection, given the wafer center, the following steps are performed:

Step 1. take an FOV 310, image1, along the wafer's center line on the left (this could also be the edge die for one-step alignment).

Step 2. take another FOV 312, image2, along the wafer's center line on the right, symmetric to the left FOV with respect to the wafer center.

Step 3. call Registration(translations, confidence, image1, image2, . . . ).

Step 4. if (confidence.maxxCorrlst>=T1 and confidence.measure>=T2

Stop. Output translations and compute rotational angle.

Step 5. Perform a spiral search by taking another FOV above or below with P% overlap, go to Step 3.

Step 6. Repeat Step 4 and Step 5 until the condition in Step 4 is satisfied or signal it is out of the search range predefined.

Step 7. If no match is found within the search range, output a failure signal and handle the case.

The data should be taken along the wafer centerline detected above, or along a parallel line (where features are guaranteed to present such as where template image is taken) close to the center to assure rotational accuracy.

The parameters are the same as in Wafer Center Detection. Note P% overlap in one direction (in case of spiral search, Y) will guarantee a (50%+P%/2) overlap area between a pair of FOVs in the worst case of gridding (gridding is where the data are actually taken with respect to the real location corresponding to its matching FOV).

The techniques described above provide a number advantageous characteristics. Noise, including fixed-pattern (D/C noise), time-varying pattern (A/C noise), and random noise, may be removed up to 100% by a novel filter implemented in the spatial domain. This filter takes a different form for different data used. Generally, it first enhances edges of high-frequency spatial features. Only strong features can pass the filter and noise is left out of the process. The gray-scale edge strength data, instead of raw intensity/phase, is then used in the following correlation process.

The correlation process is implemented in Fourier domain for speed and efficiency. In most embodiments a Fast Fourier Transform (FFT) is used to implement the Fourier transform operations.

The use of a confidence value for each match is advantageous. This confidence value is defined using the peak pattern of 2-D correlation surface. Together with correlation coefficient, this confidence value provides a reliable measure of the quality of image matching.

Providing a mechanism for a fully automated searching (in combination with a mechanical translation of the target object) from as many fields of view (FOVs) as required until the right target is matched is also advantageous. The quality of each move is gauged by a confidence defined during registration computation process, and the confidence value can further be used to accept a match or reject it and initiate a new search.

Automated wafer rotational alignment fully automates the correction of any wafer rotational errors. This is important for initial wafer setup in a wafer inspection system. It reduces setup time of operators and achieves the required accuracy for wafer navigation. The registration system provides the inspection system a robust, reliable, and efficient sub-system for wafer alignment.

The methods described promote flexibility in accepting of a variety of input data. In case of DDH wafer rotational alignment, this method may accept five major data formats and compute registration parameters directly based on these data: a. complex frequency data; b. complex spatial data; c. amplitude data extracted from a hologram; d. phase data extracted from a hologram; and e. intensity-only data. This flexibility provides opportunities to develop more reliable and efficient system as a whole.

Comparing Holographic Images

The present invention also includes systems and methods for comparing holographic images for the purpose of identifying changes in or differences between objects. As shown in FIG. 8, the imaging system, depicted generally at 340 includes the primary components: 1) mechanical positioning system 380 with computer control linked to a system control computer 350; 2) optical system 370 for creating a hologram including an illumination source; 3) data acquisition and processing computer system 360; 4) processing algorithms operable to execute on processing system 360 and may also include 5) a system for supervisory control of the subsystems (not expressly shown).

Imaging system 340 operates by positioning, in up to six degrees of freedom (x, y, theta, z, tip, tilt) one instance of an object in the field of view (FOV) of the optical system and acquiring a digital hologram using acquisition system 360 and performing the first stage of hologram processing. The resulting intermediate representation of the image wave may be stored in a temporary buffer.

Positioning system 380 is then instructed to move to a new location with a new object in the FOV and the initial acquisition sequence is repeated. The coordinates that the positioning system uses for the new location is derived from a virtual map and inspection plan. This step and acquire sequence is repeated until a second instance of the first object is reached.

A distance-measuring device is preferably used in combination with positioning system 380 to generate a set of discrete samples representative of the distance between the object and the measuring device. A mathematical algorithm is then used to generate a map with a look-up capability for determining the target values for up to three degrees of freedom (z, tip, tilt) given as input up to three input coordinates (x, y, theta).

At this point optics system 370 acquires the hologram of the second instance of the object and it is processed to generate an intermediate representation of the image wave. The corresponding representation of the first instance is retrieved from the temporary buffer and the two representations are aligned and filtered. Many benefits can be realized at this point by performing unique processing on the representation of the object in the frequency domain. A comparison (reference difference image description) between these two instances may be made and the result stored in a temporary buffer. This process may be repeated for additional FOVs containing second instances of the objects.

Positioning system 380 reaches a third instance of the object and the two previous steps (intermediate representation and comparison to second instance) are completed. The results of the comparison between the first and second instance is retrieved from the temporary buffer and a noise suppression and source logic algorithm may preferably be applied to the retrieved and current comparisons.

The results may then be analyzed and summary statistics generated. These results are conveyed to the supervisory controller. This cycle is repeated as new instances of the objects are acquired.

Generating the Difference between Complex Images

The present invention contemplates variations for generating the difference between two complex images.

An amplitude difference may be utilized. First, both complex images are preferably converted to an amplitude representation, and the magnitude of the difference between the resulting amplitudes (pixelwise) is computed. In one embodiment, this represents the difference in reflectance between the two surfaces being imaged.

A phase difference may be utilized. First both complex images are preferably converted to a phase representation and the effective phase difference between the resulting phase values (pixelwise) is computed. This may be performed directly as described, or by computing the phase of the pixelwise ratio of the two images after they have each been amplitude normalized. In one embodiment this represents a height difference between the two surfaces being imaged.

Also, a vector difference may be utilized. First the two complex images are subtracted directly in the complex domain, then the amplitude of the resulting complex difference is computed. This difference combines aspects of the amplitude difference and phase difference in an advantageous way. For example, in situations where the phase difference is likely to be noisy, the amplitude is likely to be small, thus mitigating the effects of the phase noise on the resulting vector difference.

Aligning and Comparing Two Consecutive Difference Images

The present invention further contemplates the alignment and comparison of two consecutive difference images in order to determine which differences are common to both. The amount to shift one difference image to match the other is typically known from earlier steps performed to compute the difference images originally; namely, image A is shifted by an amount a to match image B and generate difference image AB, while image B is shifted by an amount b to match image C and generate difference image BC. The appropriate amount to shift image BC to match image AB is therefore −b. Three alternate approaches to determining which differences the two difference images have in common are described below.

In one embodiment, the difference images are thresholded, then one of the two thresholded images is shifted by the appropriate amount, rounded to the nearest whole pixel. The common differences are then represented by the logical-AND (or multiplication) of the shifted and unshifted thresholded difference images.

In another embodiment the difference images are first shifted by the appropriate (subpixel) amount before thresholding and then the image is thresholded. The common differences are then computed by a logical-AND (or multiplication) as above.

In another embodiment, one of the difference images is shifted by the appropriate (subpixel) amount and combined with the second image before thresholding. The combination of the two images can be any one of several mathematical functions, including the pixelwise arithmetic mean and pixelwise geometric mean. After combining the two difference images, the result is then thresholded.

### EXAMPLE OPERATIONS

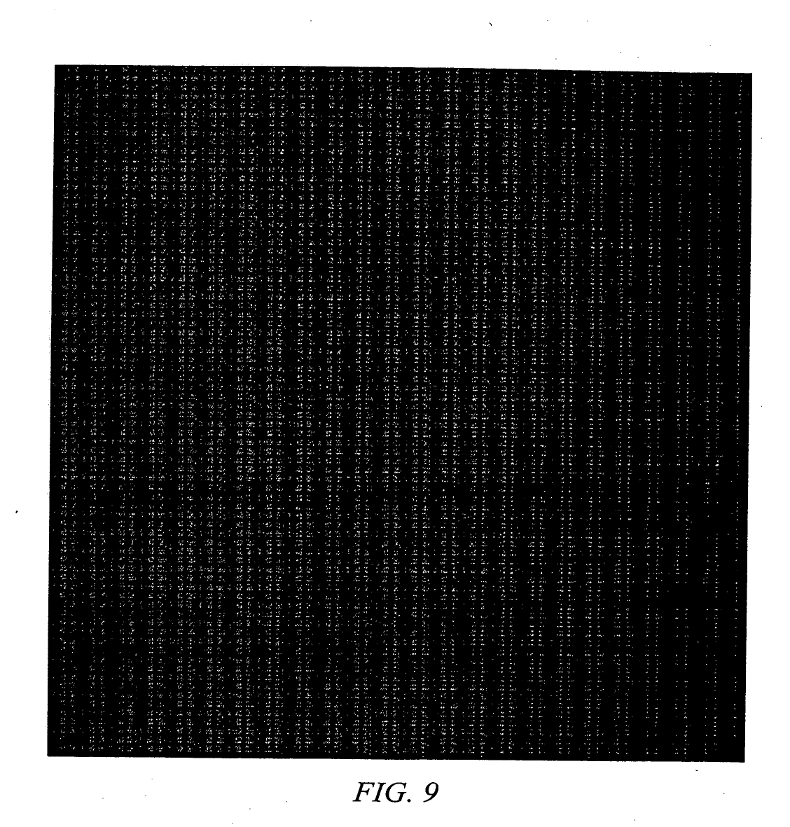

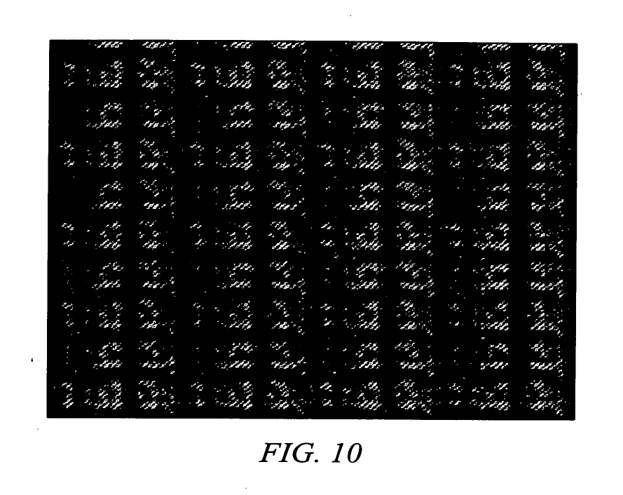

The discussion below provides a description of example operations of the present invention. First, a hologram is acquired with a CCD camera (as shown in FIGS. 9 and 10) and stored in memory. The object wave is defined as

A(x,y)e^{i(\vec{k}}^{_{A}}^{\vec{r}+φ}^{_{A}}^{(x,y))}.

and the reference wave as

B(x,y)e^{i(\vec{k}}^{_{B}}^{\vec{r}+φ}^{_{B}}^{(x,y))}.

The intensity of the recorded hologram, ignoring camera nonlinearities and noise, is:

Iₕₒₗ=|A(x,y)e^{i(\vec{k}}^{_{A}}^{\vec{r}+φ}^{_{A}}^{(x,y))}+B(x,y)e^{i(\vec{k}}^{_{B}}^{\vec{r}+φ}^{_{B}}^{(x,y))}|² (1)

The phase difference Δφ(\vec{r}) between the two waves is defined as Δφ(\vec{r})=(φ_{dA}−φ_{B}) and the vector difference Δ\vec{k}, which represents the angle between the two arms, as Δ\vec{k}=(\vec{k}_{A}−\vec{k}_{B}). Equation (1) simplifies to:

Iₕₒₗ=A²(\vec{r})+B²(\vec{r})+2μ₀A(\vec{r})B(\vec{r})cos(Δ\vec{k}\vec{r}+Δφ(\vec{r})) (2)

where μ₀ represents the coherence factor. Edgar has documented further details along these lines.

In preferred embodiments this step may be implemented either as a direct image capture and transfer to memory by a digital holographic imaging system itself, or simulated in an off-line program by reading the captured image from disk. In this particular preferred embodiment, the image is stored as 16-bit grayscale, but with 12 bits of actual range (0-4095) because that is the full range of the camera.

Next, the holographic image is preferably processed to extract the complex wavefront returned from the object as shown in FIG. 11. In one preferred embodiment, a Fast Fourier Transform (FFT) is performed on the captured (and optionally enhanced) hologram. The FFT of the hologram intensity is expressed as:

FFT{Iₕₒₜ}=δ₍\vec{q}=0)*FFT{A²(\vec{r})+B²(\vec{r})}+μ₀·δ_{(\vec{q}=-Δ\vec{k})}*FFT{A(\vec{r})B(\vec{r})e^{i(Δ\vec{k}\vec{r}+Δφ)}}+μ₀·δ_{(\vec{q}=Δ\vec{k})*}FFT{A(\vec{r})B(\vec{r})e^{i(Δ\vec{k}\vec{r}+Δφ)}}

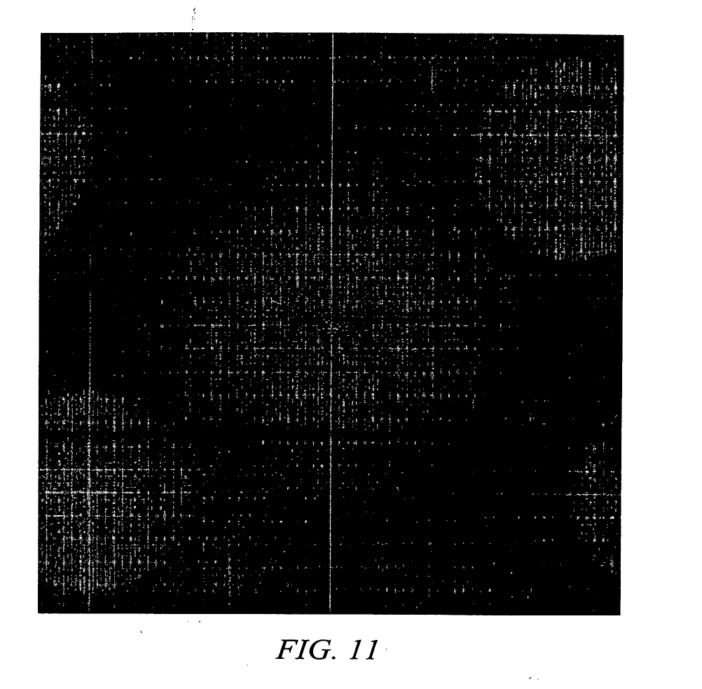

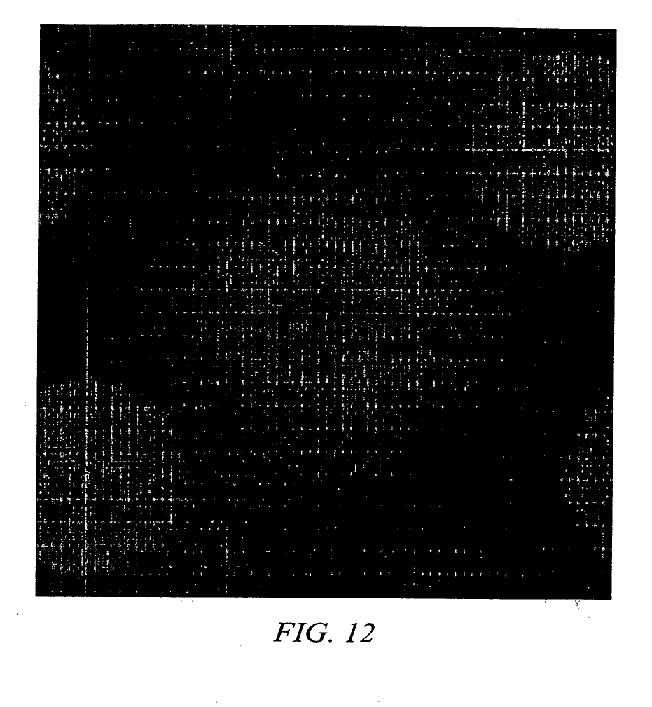

Next, a carrier frequency of a holographic image is found. In one embodiment, this first requires that the frequency where the sideband is centered, as shown in FIG. 12, must be located in order to isolate the sideband properly. This may either be done on the first hologram processed and the same location used for all subsequent images, or the carrier frequency can be relocated for every single hologram. First the location \vec{q}=Δ\vec{k} (or \vec{q}=−Δ\vec{k}) from the hologram FFT in equation (2) is sought. Because the modulus of the sidebands exhibits peaks at these two locations, the desired location can be found by searching the modulus of FFT{Iₕₒₗ} away from \vec{q}=0.

In some embodiments a search area for the sideband is defined as a parameter. The modulus of the hologram FFT is computed in the defined area, and the location of the maximum point is chosen as the carrier frequency. The search area may be specified as a region of interest (maximum and minimum x and y values) in all implementations.

In a particular embodiment, the carrier frequency is computed to sub-pixel accuracy by interpolation of the FFT modulus in the area of the found maximum. To correct for the sub-pixel location of the carrier frequency, the FFT is then modulated by a phase-only function after isolating the sideband

The search area for the sideband, may be specified either as a region of interest in the Fourier domain or as the number of pixels away from the x and y axes not to search in the Fourier domain. In some embodiments this parameter may be selectively modified. Alternatively, a user may optionally set the manual location of the sideband, which sets the carrier frequency location to a fixed value that is used for all images. (In the a particular embodiment, the same effect can be achieved by setting the search area to be a single point.) For an inspection series, the carrier frequency may be assumed to be stable and therefore need not be recomputed for each hologram. The carrier frequency can be found once and that frequency used for all subsequent holograms during the same inspection.

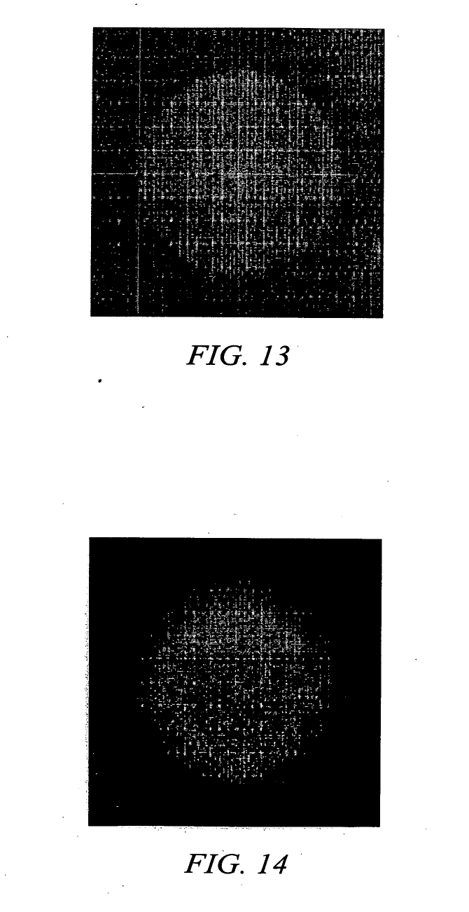

After the sideband is located, a quadrant of the hologram FFT centered at the carrier frequency is extracted as shown in FIG. 13. This isolation of the sideband quadrant takes one of the sideband terms from equation (3) and modulates it to remove the dependence on Δ\vec{k}\vec{r}:

sideband≡μ₀·FFT{A(\vec{r})B(\vec{r})e^{iΔφ}} (4)

Implementation of this step is straightforward. Note that in some embodiments, a quadrant is not extracted from the FFT, but rather the FFT is recentered at the carrier frequency and left at its original resolution.

The extracted sideband may then filtered. In a particular embodiment, a Butterworth lowpass filter is applied to the extracted sideband to reduce the effect of any aliasing from the autocorrelation band and to reduce noise in the image.

The lowpass filter H(\vec{q}) is applied to the sideband as shown in FIG. 14. The filtered sideband is the FFT of the complex image wave ψ(\vec{r}) that we wish to reconstruct:

FFT{ψ(\vec{r})}=sideband·H(\vec{q}) (5)

The Butterworth lowpass filter is defined by the equation:

$$H ( \vec{q} ) = \frac{1}{1 + {( \vert \vec{q} \vert / {q}_{c} )}^{2 N}} \qquad ( 6 )$$

where q_{c} is the cutoff frequency of the filter (that is, the distance from the filter center where the gain of the filter is down to half its value at |\vec{q}|=0) and N is the order of the filter (that is, how quickly the filter cuts off).

In embodiments where off-axis illumination is used, the lowpass filter may need to be moved off-center to capture the sideband information more accurately. Letting \vec{q}_{off} represent the location where we wish to place the center of the filter (the offset vector), the equation for the Butterworth filter is:

$$H ( \vec{q} ) = \frac{1}{1 + {( \vert \vec{q} - {\vec{q}}_{off} \vert / {q}_{c} )}^{2 N}} \qquad ( 7 )$$

In preferred embodiments the Butterworth filter should be computed only once for the given parameters and image size and stored for use with each image.

In preferred embodiments the cutoff frequency, also called the filter “size” or “radius”, and order of the filter must be specified.

If an off-axis filter is desired, the offset vector for the center of the filter should also be specified; this parameter should also be selectively adjustable. In a preferred embodiment a flag indicating whether to use a lowpass filter or bandpass filter may allow a use to select the type of filter employed in the processing software.

In some embodiments, processing software programs have the ability to substitute a bandpass filter for the lowpass filter. Using the bandpass filter has been shown to improve defect detection performance on particular defect wafers. The bandpass filter is implemented as a series multiplication of Butterworth lowpass and highpass filters; the highpass filter may be defined as “one minus a lowpass filter” and has the same type of parameters to specify as the lowpass filter.

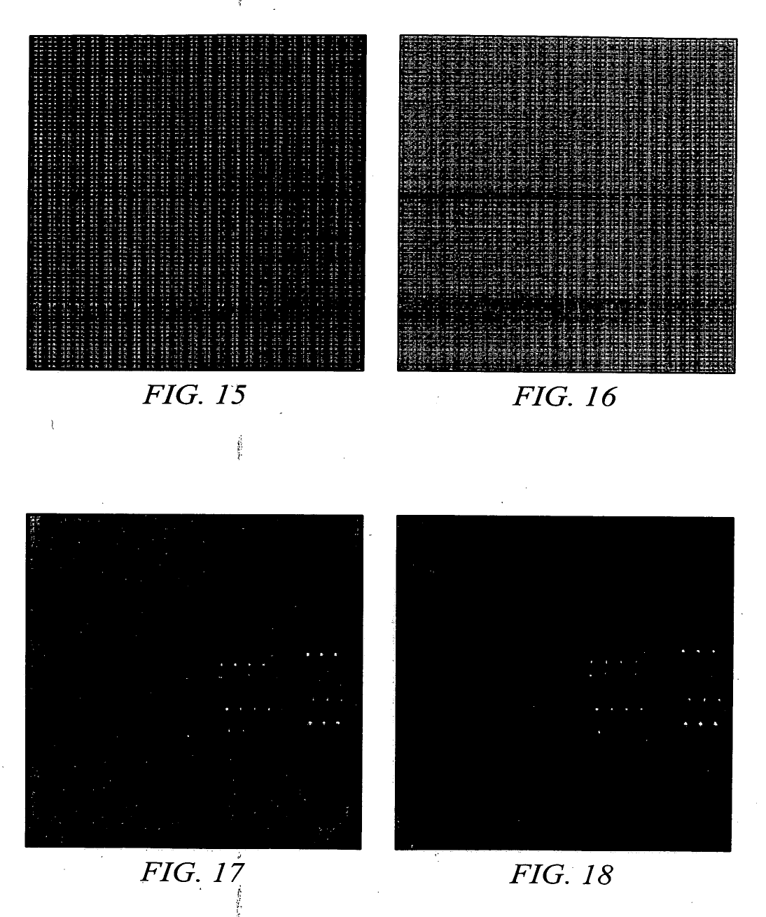

Next the inverse Fast Fourier Transform (IFFT) is performed on the filtered sideband to derive the complex image wave to produce a magnitude image and phase image as shown FIGS. 15 and 16, respectively. The IFFT of the filtered sideband yields:

ψ(\vec{r})=μ₀A(\vec{r})B(\vec{r})e^{iΔψ(\vec{r})}

where it has been assumed that the aperture of the lowpass filter perfectly isolates the sideband. In practice, this is not possible, but the assumption is necessary to achieve a tractable expression, and equation (7) does represent the results reasonably well.

If the phase of the resulting complex image is not flat enough (i.e., there are several phase wraps across the image), flat field correction may be applied to improve the results. This consists of dividing the complex image by the complex image of a reference flat (mirror) to correct for variations in illumination intensity and (especially) background phase.

First, φ(\vec{r}) represents the complex image of a reference flat hologram (processed as described above). The flat field corrected hologram ψ′(\vec{r}) is:

$${ψ}^{′} ( \vec{r} ) = \frac{ψ ( \vec{r} )}{φ ( \vec{r} )} \qquad ( 9 )$$

To implement this step, during a prior inspection run, a flat field hologram is processed to a complex image. That image is stored and divided pixelwise into each complex image from the run. Typically, the parameters used to generate complex images (sideband search area and filter parameters) are the same for the flat field hologram as for the inspection holograms.

The reference flat corrects for intensity as well as phase, and as a result modulus images |ψ′(\vec{r})| resulting from equation (8) may not be very useful for viewing or magnitude only processing algorithms. This problem can be alleviated by modifying the reference flat image φ(\vec{r}) to have unit modulus at every pixel. The flat field correction then only corrects for non-flat phase in the inspection images.

Differencing Operations

Differencing operations are necessary to identify difference between two corresponding complex images. One preferred method of performing differencing operation is outlined below.

After obtaining two complex images, the two images are aligned so that a direct subtraction of the two images will reveal any differences between the two. In this embodiment the registration algorithm is based on the cross-correlation of the two images. Because the registration algorithm is based on the cross-correlation of the two images, performance may be improved by removing the DC level and low-frequency variation from the images. This allows the high-frequency content of sharp edges and features to be more prominent than any alignment of low-frequency variations.

A Butterworth highpass filter H_{HP}(\vec{q}) may be applied (in the frequency domain) to each of the complex images ψ₁ and ψ₂ to be registered:

Ψₙ(\vec{q})=FFT{ψₙ}=sideband·H(\vec{q})·H_{HP}(\vec{q}) (10)

This effectively bandpass filters the images. The highpass filter H_{HP} is defined as:

$${H}_{HP} ( \vec{q} ) = 1 - \frac{1}{1 + {( \vert \vec{q} \vert / {q}_{c} )}^{2 N}} \qquad ( 11 )$$

Implementation of the highpass filtering step is straightforward. The size of the highpass filter used can be user-defined or determined as a fixed percentage of the size of the lowpass filter applied in above. The highpass filter is preferably computed once and stored for application to every image.

The cutoff frequency and order of the highpass filter H_{HP} may specified by the user or fixed to a pre-defined relationship with the lowpass filter parameters. In some embodiments it may be desirable to limit the parameters of this step to a fixed relationship with the lowpass filter parameters in order to reduce the number of user variables.

After filtering, the cross-correlation of the two images is computed. The peak of the cross-correlation surface preferably occurs at the location of the correct registration offset between the images.

The cross-correlation γ_{n,n+1}(\vec{r}) between the two bandpass filtered images is computed by taking the inverse Fourier transform of the product of the first image with the conjugate of the second image:

γ_{n,n+1}(\vec{r})=IFFT{Ψₙ(\vec{q})·Ψₙ₊₁*(\vec{q})} (12)

The registration offset between the two images corresponds to the location where the cross-correlation surface achieves its maximum. The registration offset between the two images is the value of \vec{r}, denoted \vec{r}ₘₐₓ, for which |γ(\vec{r})| is a maximum. A region centered at the origin of the cross-correlation is searched for the maximum value. Once the location of the maximum is found, a quadratic surface is fit to the 3×3 neighborhood centered at that location, and the subpixel location of the peak of the fit surface is used as the subpixel registration offset. The equation for the quadratic surface is:

ax²+bxy+cy²+dx+ey+f=0 (13)

The values of the coefficients a, b, c, d, e, and f are calculated via a matrix solve routine. A 9×6 matrix (A) of values in the 3×3 neighborhood for the terms x², xy, etc. is calculated, and the 6×1 vector of (unknown) coefficients \vec{z}=[abcdef]^{T} is formed. The values of the cross-correlation corresponding to each location are put into a 9×1 vector \vec{h}=[|γ(\vec{r}₁)||γ(\vec{r}₂)| . . . ]^{T}. The form of the matrix A is:

$$A = [ \begin{matrix}{x}_{1}^{2} & {x}_{1} {y}_{1} & {y}_{1}^{2} & {x}_{1} & {y}_{1} & 1 \\ {x}_{2}^{2} & {x}_{2} {y}_{2} & {y}_{2}^{2} & {x}_{2} & {y}_{2} & 1 \\ ⋮ & ⋮ & ⋮ & ⋮ & ⋮ & ⋮ \\ {x}_{9}^{2} & {x}_{9} {y}_{9} & {y}_{9}^{2} & {x}_{9} & {y}_{9} & 1\end{matrix} ] \qquad ( 14 )$$

The coefficients of the fitted surface are then found by solving equation (14) for \vec{z}:

A·\vec{z}=\vec{h} (15)

The location of the maximum of the quadratic surface (xₘₐₓ, yₘₐₓ) is then computed from the coefficients \vec{z} and used as the subpixel registration offset value.

$$\begin{matrix}{x}_{max} = \frac{2 c \cdot d - b \cdot e}{{b}^{2} - 4 a \cdot c} & ( 16 ) \\ {y}_{max} = \frac{2 a \cdot e - b \cdot d}{{b}^{2} - 4 a \cdot c} & ( 17 )\end{matrix}$$

The determination of the location where the cross-correlation surface is maximum can be achieved in several different ways. In one implementation, the interpolation may be performed by fitting a quadratic surface to the 3×3 neighborhood centered at the maximum, and finding the location of the maximum of the fitted surface. In another implementation, there is an option to perform this interpolation using three points in each (x and y) direction separately.

Typically the maximum registration offset must be specified, usually as a maximum number of pixels in any direction the images may be shifted relative to each other to achieve alignment.

The registration shift determination described essentially completes the registration process. Note that this process generally corresponds with the more registration process described in greater detail above.

After determining the registration shift between the two images, the first image is shifted by that amount to align it to the second image. The image ψₙ(\vec{r}) is shifted by the registration amount \vec{r}ₘₐₓ:

ψ′ₙ(\vec{r})=ψₙ(\vec{r}−\vec{r}ₘₐₓ)

Because the registration shift \vec{r}ₘₐₓ is typically a non-integer value, a method of interpolating the sampled image must be chosen. The two preferred methods for interpolation are bilinear interpolation and frequency domain interpolation. Bilinear interpolation works in the spatial domain using the four nearest whole pixels to the desired subpixel location. Assume we wish to find the interpolated value of ψ at the location (x+Δx, y+Δy), where x and y are integers and 0≦x<1 and 0≦y<1. The bilinearly interpolated value is computed as:

ψ(x+Δx,y+Δy)=(1−Δx)·[(1−Δy)·ψ(x,y)+Δy·ψ(x,y+1)]+Δx·[(1−Δy)·ψ(x+1,y)+Δy·ψ(x+1,y+1) (19)]

Frequency domain interpolation is performed using a basic shifting property of the Fourier transform:

ψ(x+Δx,y+Δy)=IFFT{Ψ(u,v)·e^{-i2π(Δx·μ+Δy·v)}} (20)

For equation (19), the range of Δx and Δy is not limited.

The two images being compared must be normalized so that when subtracted their magnitude and phase will align and yield near-zero results except at defects. There are two major methods used to normalize the complex images. In the first and simplest method, termed “complex normalization,” the first image of the pair is normalized to the second by multiplying it by the ratio of the complex means of the two images. The complex mean of an image is defined as:

$${μ}_{ψ} = \frac{1}{{N}^{2}} ( {\sum }_{\vec{r}} Re \{ ψ ( \vec{r} ) \} + i \cdot {\sum }_{\vec{r}} Im \{ ψ ( \vec{r} ) \} ) \qquad ( 21 )$$

where N² is the number of pixels in the image. The equation to normalize the image ψ′ₙ(\vec{r}) to ψₙ₊₁(\vec{r}) is:

$${ψ}_{n}^{″} ( \vec{r} ) = \frac{{μ}_{{ψ}_{n + 1}}}{{μ}_{{ψ}_{n}}} \cdot {ψ}_{n}^{′} ( \vec{r} )$$

In the second method, termed “magnitude-phase normalization,” the magnitude and phase of the images is aligned directly, rather than the real and imaginary parts. First, the means of the image magnitudes are computed:

$${μ}_{\vert ψ \vert} = \frac{1}{{N}^{2}} {\sum }_{\vec{r}} \vert ψ ( \vec{r} ) \vert \qquad ( 22 )$$

Second, the phase offset between the two images is computed. The phase difference between the two images is computed:

$${∠ψ}_{n + 1} - {∠ψ}_{n}^{′} = ∠ ( \frac{{ψ}_{n + 1}}{{ψ}_{n}^{′}} ) = {tan }^{- 1} ( \frac{{ψ}_{n + 1}}{{ψ}_{n}^{′}} )$$

To find the phase offset, we need to compute the phase shift of this phase difference image that will yield the fewest phase jumps in the image. Because this image is expected to be somewhat uniform, it is more reliable to find the phase offset that results in the greatest number of phase jumps, and then posit that correct phase offset is π radians offset from that. The result is a phase offset Δφ that will be used with the magnitude mean ratio to normalize the first image to the second:

$${ψ}_{n + 1}^{″} ( \vec{r} ) = \frac{{μ}_{\vert {ψ}_{n + 1} \vert}}{{μ}_{\vert {ψ}_{n}^{′} \vert}} \cdot {ψ}_{n}^{′} ( \vec{r} ) \cdot {ⅇ}^{- ⅈ Δ φ} \qquad ( 23 )$$

Implementation of this step is fairly straightforward from the mathematical description. The magnitude-phase normalization is often more computationally intense and may be unnecessary if the wavefront matching step is used. If wavefront matching is used, it is not necessary to perform the normalization step at all, because the wavefront matching is a form of normalization.

Wavefront matching adjusts the phase of the second image by a filtered version of the phase ratio between the images, in order to remove low-frequency variation from the difference image cause by phase anomalies. First, the phase difference between the images is found by dividing the two complex images:

$$ρ ( \vec{r} ) = \frac{{ψ}_{n}^{″} ( \vec{r} )}{{ψ}_{n + 1} ( \vec{r} )} \qquad ( 24 )$$

This ratio is then lowpass filtered in the frequency domain using a filter with a very low cutoff frequency:

ρ_{filt}(\vec{r})=IFFT{FFT{ρ(\vec{r})}·L(\vec{r})} (25)

where L(\vec{r}) is a third-order Butterworth lowpass filter with a cutoff frequency of six pixels. This filtered ratio is used to modify the second image so that low frequency variations in the phase difference are minimized:

\tilde{ψ}ₙ₊₁(\vec{r})=ψₙ₊₁(\vec{r})·ρ_{filt}(\vec{r}) (26)

Implementation of this step is straightforward using the above equations. The order and cutoff frequency of the lowpass filter used in this step are fixed. Also, note that in one preferred embodiment the second image is the one modified by this algorithm, not the first. This is to minimize the number of pixels where the ratio ρ(\vec{r}) will be undefined because of zeroes in the denominator at border pixels.

In some instances the differences among implementations for handling border pixels when shifting images may cause this step to propagate differences throughout the images. Until and unless the handling of border pixels during shifting is identical among the various implementations, the wavefront matching step will result in differences throughout the images. Typically these differences are quite small. Also, wavefront matching can cause artifacts near the borders because of the periodicity assumption of the FFT. The effects of these artifacts can extend beyond the border region excluded from defects.

The vector difference between the two registered, normalized, phase corrected images is then computed as shown in the first difference image shown in FIG. 17 and the second difference image as shown in FIG. 18. The vector difference between the images is

|Δψ_{n+1,i}(\vec{r})|=|\tilde{ψ}ₙ₊₁(\vec{r})−ψₙⁿ(\vec{r})| (27)

The implementation of this step is straightforward. Note that in alternate embodiments phase differences and magnitude differences may also be used to detect defects.

Pixels near the edges of the difference image are set to zero to preclude defect detection in those areas, which are prone to artifacts. Each pixel in the vector difference image that is within a specified number of pixels of each edge of the image is set to zero. This requires that the number of pixels at each edge to zero out must be specified. In some embodiments, the number of pixels is taken to be equal to the maximum allowed registration shift, in pixels

Defect Detection

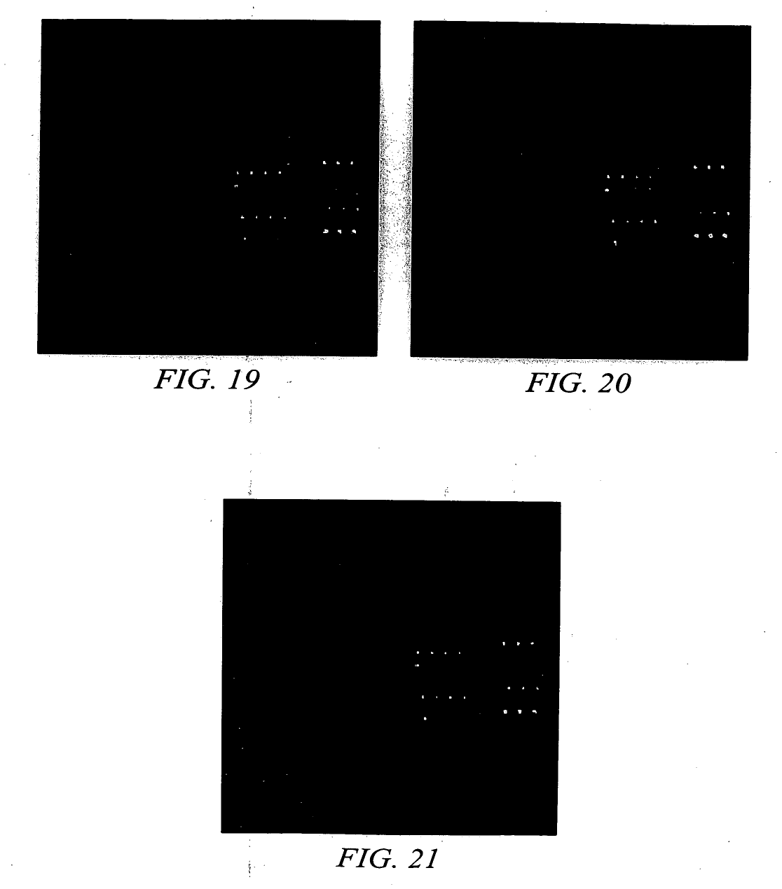

The vector difference image is thresholded to indicate the location of possible defects between each pair of images as shown in FIGS. 19 and 20. The standard deviation σ of the vector difference image |Δψ_{n+1,n}(\vec{r})| is computed. A threshold is set at a user-specified multiple of the standard deviation, kσ, and the difference image is thresholded at that value:

$${δ}_{n + 1 , n} ( \vec{r} ) = \{ \begin{matrix}1 , & \vert Δ {ψ}_{n + 1 , n} ( \vec{r} ) \vert > k σ \\ 0 , & \vert Δ {ψ}_{n + 1 , n} ( \vec{r} ) \vert \leq k σ\end{matrix} \qquad ( 28 )$$

The initial threshold value is computed based on the standard deviation of the entire difference image. In the one implementation, the threshold is iteratively modified by recomputing the standard deviation excluding pixels above the threshold until there are no further changes. This effectively lowers the threshold for images that have many defects, sometimes quite substantially. In a preferred embodiment the multiple of the standard deviation at which to threshold the image is specified by the user.

The two thresholded difference images used to ascertain which image a defect originates from are then aligned. Because the first image of any pair is aligned to the second image of the pair, the two resulting difference images are in different frames of reference. In a sequence of three complex images that are compared to each other, ψ₁, ψ₂, and ψ₃, the first thresholded difference δ_{2,1} is aligned with ψ₂, and the second difference δ_{3,2} is aligned with ψ₃. Since these two thresholded difference images will yield the defects for the image ψ₂, the image δ_{3,2} must be shifted so that it is aligned with ψ₂. Because of the binary nature of the thresholded images, it is only necessary to align the images to whole-pixel accuracy. The registration shift between the images ψ₂ and ψ₃ is already known from earlier computations to sub-pixel accuracy; this shift, \vec{r}ₘₐₓ, is rounded to the nearest whole pixel (denoted \vec{r}′ₘₐₓ) and applied to δ_{3,2} in the direction opposite to its earlier application (which shifted image 2 into alignment ith image 3):

δ′_{3,2}(\vec{r})=δ_{3,2}(\vec{r}+\vec{r}′ₘₐₓ) (29)

The implementation of this step is straightforward.

Next, a logical AND operation is applied to the aligned thresholded difference images to eliminate any detected defects that do not appear in both as shown in FIG. 21. This reduces the number of false positive defects and assigns defects to the proper image in the sequence.

The defects in the image ψ₂ found when it is compared to the corresponding images ψ₁ and ψ₃, are given by:

d₂(\vec{r})=δ_{2,1}(\vec{r})∩δ′_{3,2}(\vec{r}) (30)

In one particular embodiment the logical AND is implemented as a multiplication of the two thresholded images, since their values are limited to be either 0 or 1.

In an alternate embodiment the above steps may be reordered, so that the alignment and logical AND steps are performed before thresholding, subpixel alignment may be used instead, and the logical AND step becomes a true multiplication.

In some embodiments, the resulting defect areas may be disregarded if they fall below a certain size threshold. Also, morphological operations on the defect areas may be used to “clean up” their shapes. Shape modification may be implemented as a mathematical morphology operation, namely the morphological closing. This operator is described as follows.

Let K denote the structuring element (or kernel) for the morphological operator. Define the symmetric set \tilde{K}={−\vec{r}:\vec{r}εK}, which is a reflection of K about the origin. The translation of a set to a point \vec{s} is denoted by a subscript; for example, the set K translated to the point \vec{s} is K_{\vec{s}}. The set processing morphological erosion and dilation are defined by:

$$\begin{matrix}Erosion : d Θ \tilde{K} = \{ \vec{s} : {K}_{\vec{s}} ⊆ d ( \vec{s} ) \} = {⋂}_{\vec{r} εK} d ( - \vec{r} ) & ( 31 ) \\ Dilation : d ⊕ \tilde{K} = \{ \vec{s} : ( {K}_{\vec{s}} ⋂ d ( \vec{s} ) ) \neq Ø \} = {⋃}_{\vec{r} εK} d ( \vec{r} ) & ( 32 )\end{matrix}$$

The symbols Θ and ⊕ denote Minkowski subtraction and Minkowski addition, respectively. The erosion of a binary image d has true pixels where the structuring element K may be translated while remaining entirely within the original area of true pixels. The dilation of d is true where K may be translated and still intersect the true points of d at one or more points.

The morphological opening and closing operations are sequential applications of the erosion and dilation, as follows:

Opening: d∘K(\vec{r})=[(dΘ\tilde{K})⊕K](\vec{r}) (33)

Closing: d•K(\vec{r})=[(d⊕K)ΘK](\vec{r}) (34)

Morphological closing with a square kernel (K) is the most likely operation for shape modification of the defect map d.

Size restriction may be implement by counting the number of pixels in each connected component. This step will likely be combined with connected component analysis. In one embodiment, shape modification utilizes a mathematical morphology operation, particularly morphological closing with a 3×3 square kernel.

In a preferred embodiment the minimum defect size to accept must be specified for the size restriction operation. In some embodiments this parameter may be user-modified. For shape modification operations the size and shape of the kernel plus the type of morphological operator must be specified by the user. Additionally the user may also specify whether to use shape modification at all.

Areas with non-zero pixels in the resulting defect image dᵢ(\vec{r}) are converted to a “connected component” description. The connected component routine preferably looks for defect clusters that are continuous in the x direction. Once a linear string of defects is identified, it is merged with other blobs it may be in contact with in the y direction. Merge involves redefining the smallest bounding rectangle that completely encloses the defect cluster. A limit such as for 50 defects may be imposed in the detection routine to improve efficiency. If at any point, the defect label exceeds the limit plus a margin, the analysis is aborted. Once the entire image is scanned, the merge procedure is repeated continuously until the defects do not increase.

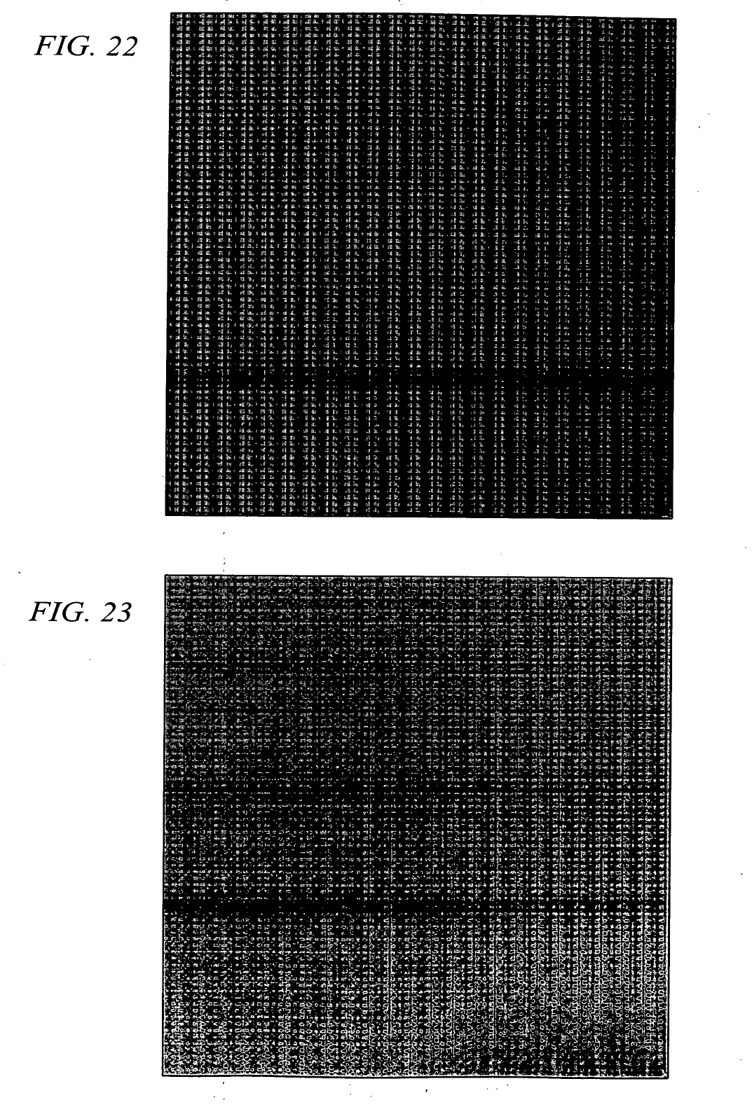

The connected components are then shown as a magnitude image as shown in FIG. 22 or a phase image as shown in FIG. 23. In one embodiment the connected components are mapped into a results file and basic statistics for the defects are computed. In one particular embodiment only the coordinates of the bounding rectangles of the defects are reported.

Although the disclosed embodiments have been described in detail, it should be understood that various changes, substitutions and alterations can be made to the embodiments without departing from their spirit and scope.

What is claimed is:

1. A method for registering corresponding intensity images comprising:
providing a first intensity image;
providing a second corresponding intensity image;
separately performing an edge enhancement operation on the first intensity image and the second intensity image;
separately performing a noise removal thresholding operation on the first intensity image and the second intensity image;
separately transforming the first intensity image and the second intensity image using a Fourier transform;
computing a coherence function using first intensity image and the second intensity image;
transforming the coherence function using an inverse Fourier transform;
performing a magnitude operation on the transformed coherence function;
calculating a confidence value based on the magnitude operation; and
determining the acceptability of the correspondence between the first intensity image and the registration using the computed confidence value.

2. The method of claim 1 further comprising providing the first intensity image and the second intensity image using a digital holographic imaging system.

3. The method of claim 1 wherein calculating the confidence value utilizes at least one identified coherent peak.

4. The method of claim 1 wherein calculating the confidence value further comprises determining the difference in strength between a first coherent peak and a second peak.

5. A method for registering holographic images comprising:
providing a first holographic image and a second corresponding holographic image;
separately transforming the first holographic image and the second holographic image using a Fourier transform;
separately performing a sideband extraction operation on the resulting first holographic image and the second holographic image;
separately filtering the resulting the first holographic image and the second holographic image using a bandpass filter;
separately transforming the resulting first holographic image and the second holographic image using an inverse Fourier transform;
separately performing a magnitude operation on the resulting first holographic image and the second holographic image;
separately performing a noise removal thresholding on the resulting first holographic image and the second holographic image;
separately transforming the resulting first holographic image and the second holographic image using a Fourier transform;
calculating a coherence function of the resulting first holographic image and the second holographic image;
transforming the coherence function using an inverse Fourier transform;
performing a magnitude operation on the resulting transformed coherence function;
calculating a confidence value based on the magnitude operation; and
determining the acceptability of the correspondence between the first holographic image and the second holographic image based upon the confidence value.

6. The method of claim 5 further comprising providing the first holographic image and the second holographic image using a digital holographic imaging system.

7. The method of claim 5 wherein calculating the confidence value utilizes at least one identified coherent peak.

8. The method of claim 5 wherein calculating the confidence value further comprises determining the difference in strength between a first coherent peak and a second peak.

9. A method for registering holographic images comprising:
providing a first holographic image and a second corresponding holographic image;
separately transforming the first holographic image and the second holographic image using a Fourier transform;
separately performing a sideband extraction operation on the resulting first holographic image and the second holographic image;
separately filtering the resulting the first holographic image and the second holographic image using a low pass filter;
separately transforming the resulting first holographic image and the second holographic image using an inverse Fourier transform;
separately performing a phase operation on the resulting first holographic image and the second holographic image;
separately performing a phase-aware edge enhancement operation on the resulting first holographic image and the second holographic image;
separately performing a noise removal thresholding on the resulting first holographic image and the second holographic image;
separately transforming the resulting first holographic image and the second holographic image using a Fourier transform;
calculating a coherence function of the resulting first holographic image and the second holographic image;
transforming the coherence function using an inverse Fourier transform;
performing a magnitude operation on the resulting transformed coherence function;
calculating a confidence value based on the magnitude operation; and
determining the acceptability of the correspondence between the first holographic image and the second holographic image based upon the confidence value.

10. The method of claim 9 further comprising providing the first holographic image and the second holographic image using a digital holographic imaging system.

11. The method of claim 9 wherein calculating the confidence value utilizes at least one identified coherent peak.

12. The method of claim 9 wherein calculating the confidence value further comprises determining the difference in strength between a first coherent peak and a second peak.

13. A method for registering holographic images comprising:
providing a first holographic image and a second corresponding holographic image;
separately transforming the first holographic image and the second holographic image using a Fourier transform;
separately performing a sideband extraction operation on the resulting first holographic image and the second holographic image;
separately filtering the resulting the first holographic image and the second holographic image using a bandpass filter;
calculating a coherence function of the resulting first holographic image and the second holographic image;
transforming the coherence function using an inverse Fourier transform;
performing a magnitude operation on the resulting transformed coherence function;
calculating a confidence value based on the magnitude operation; and
determining the acceptability of the correspondence between the first holographic image and the second holographic image based upon the confidence value.

14. The method of claim 13 further comprising providing the first holographic image and the second holographic image using a digital holographic imaging system.

15. The method of claim 13 wherein calculating the confidence value utilizes at least one identified coherent peak.

16. The method of claim 13 wherein calculating the confidence value further comprises determining the difference in strength between a first coherent peak and a second peak.

17. A method for registering holographic images comprising:
providing a first holographic image and a second corresponding holographic image;
separately transforming the first holographic image and the second holographic image using a Fourier transform;
separately performing a sideband extraction operation on the resulting first holographic image and the second holographic image;
separately filtering the resulting the first holographic image and the second holographic image using a bandpass filter;
calculating the conjugate product of the resulting first holographic image and the second holographic image;
transforming the conjugate product using an inverse Fourier transform;
performing a magnitude operation on the resulting transformed conjugate product;
calculating a confidence value based on the magnitude operation; and
determining the acceptability of the correspondence between the first holographic image and the second holographic image based upon the confidence value.

18. The method of claim 17 further comprising providing the first holographic image and the second holographic image using a digital holographic imaging system.

19. The method of claim 17 wherein calculating the confidence value utilizes at least one identified coherent peak.

20. The method of claim 17 wherein calculating the confidence value further comprises determining the difference in strength between a first coherent peak and a second peak.

21. A method for registering holographic images comprising:
providing a first holographic image and a second corresponding holographic image;
separately transforming the first holographic image and the second holographic image using a Fourier transform;
separately performing a sideband extraction operation on the resulting first holographic image and the second holographic image;
separately filtering the resulting the first holographic image and the second holographic image using a bandpass filter;
calculating the conjugate product of the resulting first holographic image and the second holographic image;
transforming the conjugate product using an inverse Fourier transform;
performing a magnitude operation on the resulting transformed conjugate product; and
performing an integer translation and subpixel modeling operation on the resulting magnitude image.

22. The method of claim 21 further comprising providing the first holographic image and the second holographic image using a digital holographic imaging system.

23. A method for registering a test holographic image and a reference holographic image in a digital holographic imaging system comprising:
providing a test sideband from the test image and a reference sideband from the reference image;
separately filtering the test sideband and the reference sideband using a bandpass filter;
calculating the conjugate product of the resulting test sideband and reference sideband;
transforming the conjugate product using an inverse Fourier transform;
performing a magnitude operation on the resulting transformed conjugate product; and
performing an integer translation and subpixel modeling operation on the resulting magnitude image.

24. The method of claim 23 further comprising providing the test holographic image and the reference holographic image using a digital holographic imaging system.

25. A method for comparing corresponding holographic images comprising:
obtaining a first holographic image;
obtaining a second holographic image corresponding to the first holographic image;
comparing the first holographic image and the second holographic image and obtaining a first difference image description;
obtaining a third holographic image corresponding to the second holographic image;
comparing the second holographic image and the third holographic image and obtaining a second difference image description; and
comparing the first difference image and the second difference image description.

26. The method of claim 25 further comprising comparing the first holographic image, the second holographic image and the third holographic image in the frequency domain.

27. The method of claim 25 further comprising comparing the first holographic image, the second holographic image and the third holographic image in the spatial domain.

28. A method for generating a difference between a first complex image and a second corresponding complex image comprising:
converting the first complex image and the second complex image to an amplitude representation; and
computing the magnitude of the difference between the resulting amplitude representations.

29. A method for generating a phase difference between a first complex images and a corresponding second complex image comprising:
converting the first complex image and the second complex image to a first phase image and a second phase image; and
computing the effective phase difference between the first phase image and the second phase image.

30. A method for generating a difference between first complex image and a second corresponding complex image comprising:
subtracting the first complex image and the second complex image in the complex domain; and
computing the amplitude of the resulting complex difference.

31. A method for determining common differences between difference images in a digital holographic imaging system comprising:
thresholding a first difference image and a second difference image; and
shifting one of the thresholded images by a selected amount such that the common differences of the both difference images are represented by a logical AND of the shifted thresholded image and the unshifted thresholded difference image.

32. A method for determining common differences between difference images in a digital holographic imaging system comprising:
shifting one of the difference images by a selected amount;
thresholding the shifted difference image; and
computing the common differences by performing a logical-AND of the shifted unthresholded image and the shifted thresholded image.

33. A method for determining common differences between two corresponding difference images in a digital holographic imaging system comprising:
shifting the first difference image by a selected amount;
combining the shifted image with the second image; and
thresholding the combined image.
